(19) United States
(12) Patent Application Publication
(10) Pub. No.: US 2010/0252077 A1
(43) Pub. Date: Oct. 7, 2010

(54) DRILL-MOUNTED PAINT ROLLER CLEANER

(76) Inventor: Daniel E. Muraske, White Cloud, MI (US)

Correspondence Address: MCGARRY BAIR PC, 32 Market Ave. SW, SUITE 500, GRAND RAPIDS, MI, 49503, US

(21) Appl. No.: 12/677,332

(22) PCT Filed: Feb. 1, 2007
(86) PCT No.: PCT/US2007/061429

§ 371 Date: Mar. 10, 2010

(51) Int. Cl. B08B 7/00; B08B 1/02

(52) U.S. Cl. 134/32; 15/3

(57) ABSTRACT

A paint roller cleaner comprises a rod removably receivable by a motorized drill. A fork extends from the rod and is configured for removable insertion into one end of a paint roller. High speed rotary motion can be imparted to the paint roller so that any paint and foreign matter present on the paint roller is quickly removed.

### BACKGROUND OF THE INVENTION

1. Field of the Invention

The invention relates to tools for cleaning painting supplies, and in particular to a drill-mountable tool for cleaning paint rollers.

2. Description of the Related Art

Paint rollers for painting primarily flat surfaces are well known. A paint roller consists of a cylindrical frame covered with a fibrous material. In order to use a paint roller, a painter simply mounts the paint roller on a suitable handle, thoroughly wets the paint roller with paint, and rolls the paint roller along a surface to be painted by applying force to the handle.

A common problem encountered by painters who use paint rollers is the difficulty of cleaning a paint roller after use. The paint soaks deep into the fibrous material, which makes it tough to thoroughly clean the roller. In an attempt to remove as much of the paint as possible, paint rollers are typically scraped along a surface, such as an edge of a paint can. Due to the paint roller's cylindrical shape, the roller must be rotated slightly after each section is scraped. Once the entire outer surface of the paint roller has been scraped, the paint roller is typically scrubbed by hand in a sink or basin to remove as much of the soaked-in paint as possible. The paint roller is then allowed to air dry.

The aforementioned cleaning method is not only time-consuming, but it is also quite messy. The painter cleaning the paint roller will have to painstakingly rotate the paint roller by hand after scraping each section. This increases the likelihood that paint will be transferred from the painter's hand to a surface other than the one being painted, creating an unwanted stain. The same problem is caused by the hand cleaning of the paint roller with water. As the paint mixes with the water, splashes can cause an even larger mess. This method also fails to reliably remove all of the paint soaked into the paint roller, as only the outermost portion of the fibrous material receives suitable force for removing the paint. Air drying the paint roller after cleaning can take several hours or more, which forces the painter to purchase an additional paint roller to use in the meantime.

Spinning paint roller cleaners are known. However, the cleaner must be operated with two hands, and spins the roller at a relatively slow speed, thereby resulting in a less than optimal cleaning effort.

There is a need for a means of cleaning and drying a paint roller that requires minimal time while greatly reducing mess and increasing cleaning efficiency.

### SUMMARY OF THE INVENTION

A paint roller cleaner comprises a rod removably receivable by a motorized drill. A fork extends from the rod and is configured for removable insertion into one end of a paint roller. High speed rotary motion can be imparted to the paint roller so that any paint and foreign matter present on the paint roller is quickly removed.

### BRIEF DESCRIPTION OF THE DRAWINGS

In the drawings:

FIG. 1 is a perspective view of the paint roller cleaner according to the invention.

FIG. 2 is an exploded view of the paint roller cleaner of FIG. 1 as used with a paint roller and a conventional drill.

FIG. 3 is a perspective view of the assembly of FIG. 2 as it would be used to clean the paint roller in a bucket.

### DESCRIPTION OF AN EMBODIMENT OF THE INVENTION

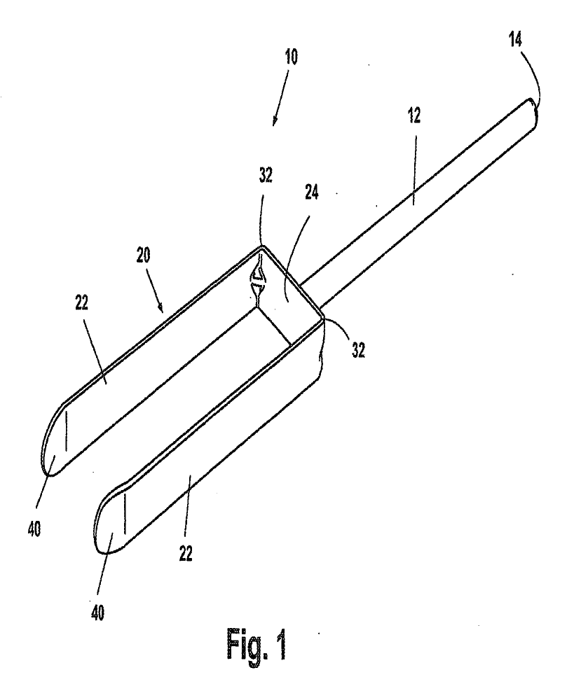

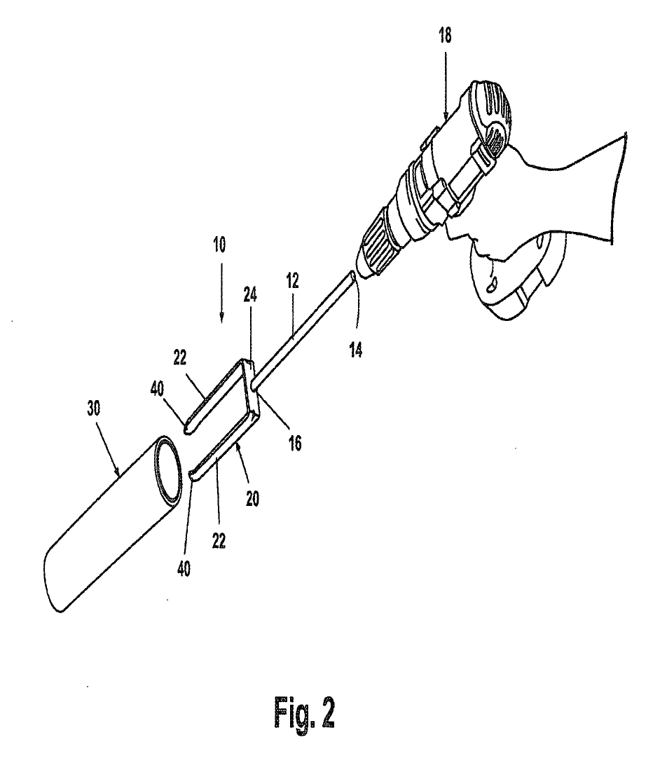

Referring to the drawings, and specifically to FIG. 1, an embodiment of a paint roller cleaner 10 according to the invention is illustrated. The paint roller cleaner 10 is an assembly comprising a rod 12 and a fork 20. The rod 12 is adapted for insertion at one end 14 into a drill chuck of a conventional cordless electric drill 18 (FIG. 2). The second end 16 of the rod 12 transitions to the fork 20. The fork comprises two parallel tines 22 spaced apart and rigidly connected to a base 24. The fork 20 is adapted for removable insertion into a conventional paint roller 30 comprising an annular wall overlain with an absorbent material for holding and applying paint, stain, varnish, and other liquid or semi-liquid materials.

The rod 12 is preferably cylindrical in shape, although it can be formed in any suitable shape, such as square or octagonal. The rod 12 comprises a durable, rigid material having sufficient strength for the purposes described herein, and suitable for immersion in water, stains, varnishes, paint, and the like, such as steel or high-strength plastic. The rod 12 has a length suitable for accommodating different bucket and/or paint roller sizes, as will be discussed in more detail hereinafter. An exemplary length is between 145 mm and 155 mm.

The fork 20 is illustrated as comprising two tines 22 formed integrally with the base 24, of a material similar to that of the rod 12. A greater number of evenly-spaced tines can be utilized, in which case a circular base would be used. Preferably, the fork 20 comprises a strap of material having a generally uniform thickness and bent into a generally “U” shape to form the base 24 and tines 22. Alternatively, the base 24 and tines 22 can be fabricated of separate pieces welded together. The width of the base 20 and spacing of the tines 22 are adapted to correspond to the inner radius of the paint roller 30. Each of the two tines 22 extends from an end 32 of the base 24. Preferably, the tines 22 are oriented perpendicular to the base 20, and terminate in an inwardly tapered end 40 formed by bending each of the tines 22 inward at the end portion to facilitate the insertion of the tines 22 into the roller 30, as illustrated in FIG. 2. An exemplary angle for each inwardly tapered end 40 is 15° relative to a longitudinal axis of the roller cleaner 10.

The rod 12 and fork 20 are joined by welding the second end 16 of the rod 12 to the fork 20 at a midpoint of the base 24 to provide a symmetrical, balanced assembly capable of spinning at high speed without excessive vibration.

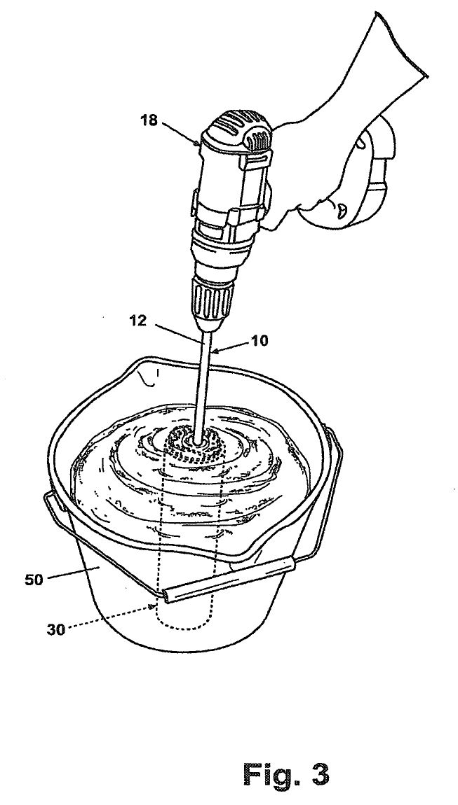

In order to use the paint roller cleaner 10, a user can first fill at least one bucket 50 with water, as illustrated in FIG. 3. Optimally, the user will fill two buckets 50 with water and leave a third bucket 50 empty.

As illustrated in FIG. 2, the first end 14 of the rod 12 is inserted into the drill chuck of the drill 18 which is then tightened. The paint roller 30 can then be slidably inserted over the fork 20 in a suitable manner. Preferably, the tines 22 are adapted with sufficient resilience to deflect inwardly when inserted into the roller 30 so that the roller 30 is securely retained on the fork 20 by the outward spreading of the tines 22. The inwardly tapered ends 40 of the tines 22 enable easy insertion of the tines 22 into the roller 30.

The user can then completely submerge the paint roller 30 into the bucket 50 filled with water, and can operate the drill 18 to spin the paint roller 30 in the water. This will urge paint and foreign matter to be expelled from the roller 30 into the surrounding water by both centrifugal action and the flushing effect of the water, thus quickly cleaning the paint roller 30.

In order to obtain the best results possible, the user can repeat the spinning process in the second bucket 50 of water. For rollers having a particularly heavy nap, or a particularly viscous paint, additional buckets of water can be used until the roller has been satisfactorily cleaned.

Once the paint roller 30 has been cleaned as desired, the paint roller 30 can be dried quickly and easily by spinning the paint roller 30 in an empty bucket. Centrifugal action will once again act on any paint and foreign matter, including water, remaining in the fibrous material of the roller 30. This will cause such particles and liquid to be thrown towards the sides of the bucket 50 away from the paint roller 30, thus drying the paint roller 30.

The paint roller cleaner has been illustrated and described for use with a cordless electric drill. Such a drill is readily available, can be utilized in areas without a supply of electricity, and is not susceptible to generating an electric shock to a user if inadvertently dropped in water or other liquid. However, the paint roller cleaner can be utilized with a corded drill provided suitable safety precautions are taken.

The paint roller cleaner has also been illustrated and described for cleaning of a roller in buckets of water. Alternatively, the paint roller cleaner can be used in a laundry tub, janitorial sink, and the like, where a steady supply of clean, fresh water is available to clean the roller.

The invention thus provides an effective and efficient means of quickly and easily cleaning a paint roller 30 with minimal mess. The user never has to clean the paint- covered paint roller 30 by hand, reducing the adverse health effects of handling finishes having toxic components. In addition, the spinning action serves to more effectively separate the paint and foreign matter from the fibrous material than scrubbing the paint roller, enabling a more thorough cleaning. The ability to dry the brush roller 30 in a short amount of time also prevents the user from having to buy additional rollers, saving both time and money. Finally, cleaning the roller can be completed with one hand, freeing the remaining hand for other tasks, such as manipulating washing and drying buckets, thereby speeding the cleaning operation.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. (canceled)

2. A paint roller cleaner according to claim 11, wherein the apparatus is a drill.

3. A paint roller cleaner according to claim 11, wherein the at least two tines terminate in inwardly-angled ends for facilitating insertion of the at least two tines into the roller.

4. A paint roller cleaner according to claim 11, wherein the at least two tines can flex and exert a radially-outwardly directed force against an annular wall of the roller to secure the roller on the fork.

5. (canceled)

6. A method of cleaning a paint roller according to claim 12 and further rotating the paint roller until the paint roller is clean.

7. A method of cleaning a paint roller according to claim 12 and further rotating the paint roller in a fluid.

8. A method of cleaning a paint roller according to claim 7 and further rotating the paint roller after removing the paint roller from the fluid.

9. A method of cleaning a paint roller according to claim 7 and further rotating the paint roller in an empty container.

10. A method of cleaning a paint roller according to claim 12 wherein the apparatus is a drill.

11. A paint roller cleaner for cleaning a tubular, open-ended paint roller defining a roller longitudinal axis, the paint roller cleaner comprising:
an elongate rod defining a rod longitudinal axis, having a first end and a second end, the first end being coupleable with an apparatus for selectively imparting a rotary motion to the rod about the rod longitudinal axis; and
a fork comprising a plate-like base having a first face and an opposed second face, rigidly coupled with the second end of the rod and with at least two cantilevered, elongate, plate-like tines, the at least two tines spaced symmetrically about the rod longitudinal axis, extending orthogonally away from the second face, and adapted for radially-inward flexure and removable installation in the paint roller, the rod extending orthogonally away from a centroid of the first face;
wherein the rod can be fixedly coupled with the apparatus and the paint roller can be fixedly coupled with the at least two tines and rotated so that material present on or in the paint roller is centrifugally removed.

12. A method of cleaning a tubular, open-ended paint roller defining a roller longitudinal axis, the method comprising:
selecting a paint roller cleaner including
an elongate rod defining a rod longitudinal axis, having a first end and a second end, the first end being coupleable with an apparatus for selectively imparting a rotary motion to the rod about the rod longitudinal axis; and
a fork comprising a plate-like base having a first face and an opposed second face, rigidly coupled with the second end of the rod and with at least two cantilevered, elongate, plate-like tines, the at least two tines spaced symmetrically about the rod longitudinal axis, extending orthogonally away from the second face, and adapted for radially-inward flexure and removable installation in the paint roller, the rod extending orthogonally away from a centroid of the first face;
installing the at least two tines in a paint roller to fixedly couple the paint roller to the paint roller cleaner; and
rotating the paint roller cleaner about the roller longitudinal axis to centrifugally remove material present on or in the paint roller.

13. A method of cleaning a paint roller according to claim 12 and further fixedly coupling the rod to the apparatus.

14. A method of cleaning a paint roller according to claim 12 and further inwardly deflecting the at least two tines to install the at least two tines in a paint roller.
